(19) United States
(12) Patent Application Publication
(10) Pub. No.: US 2025/0287056 A1
(43) Pub. Date: Sep. 11, 2025

(54) REDUCING RUNTIME OF MEDIA CONTENT WHILE RETAINING CONTEXT

(71) Applicant: TiVo Platform Technologies LLC, San Jose, CA (US)

(72) Inventors: Govind RAVEENDRANATHAN NAIR, Bangalore (IN); Sangeeta PARIDA, Bangalore (IN); Vasanth Raj RAJANNA, Bangalore (IN)

(21) Appl. No.: 19/076,171

(22) Filed: Mar. 11, 2025

Related U.S. Application Data
(60) Provisional application No. 63/563,849, filed on Mar. 11, 2024.

(51) Int. Cl. H04N 21/2387; H04N 21/4545

(52) U.S. Cl. CPC H04N 21/2387; H04N 21/45457

(57) ABSTRACT

Generally disclosed herein is a mechanism to expedite viewing of media content by automatically skipping scenes that are not central to the story or plot and not needed to fully understand and appreciate the media content. In detecting the scenes that can be skipped, one or more processors may divide media content into a plurality of segments and identify removable scenes within the segments that can be removed or skipped without affecting the storyline or viewing quality of the media content. The remaining segments are played consecutively, such as by removing the identified removable scenes or skipping past them, such that a shortened version of the media content is presented to the viewer.

### CROSS-REFERENCE TO RELATED APPLICATIONS

The present application claims the benefit of the filing date of U.S. Provisional Patent Application No. 63/563,849, filed on Mar. 11, 2024, the disclosure of which is hereby incorporated by reference.

### BACKGROUND

Media content provides a popular form of entertainment but can often be time-consuming. For example, viewers can stream one or more episodes of a series using a streaming platform, but if each episode is approximately an hour it can take a lot of time to get through the series. Sometimes viewers become bored during the streaming, and turn to other devices, such as cell phones, during the less interesting parts of the media content. Other times, viewers may fast-forward through the less interesting parts. However, this poses a risk that the viewer will become distracted or fast-forward too far and miss the important context in the media content.

### BRIEF SUMMARY

Generally disclosed herein is a mechanism to expedite viewing of media content by automatically skipping scenes that are not central to the story or plot and not needed to fully understand and appreciate the media content. In detecting the scenes that can be skipped, one or more processors may divide media content into a plurality of segments and identify removable scenes within the segments that can be removed or skipped without affecting the storyline or viewing quality of the media content. The remaining segments are played consecutively, such as by removing the identified removable scenes or skipping past them, such that a shortened version of the media content is presented to the viewer.

A segment may include relevant scenes and removable scenes. The relevant scenes may include major scenes where physical actions are involved, or the main characters are exchanging dialoguing, etc. The removable scenes may include auxiliary scenes where no major physical actions are involved, or only background music plays without any changes in the camera focus or angles, etc. The segment may be analyzed to identify the removable portions using machine learning models. For example, machine learning models may be trained to identify duplicate scenes or scenes that are irrelevant to the storyline of the media content. The removable scenes may be tagged as “removable” and removed from the media content or skipped during the playback of the media content such that viewing can be expedited by displaying only the relevant portions of the media content.

An aspect of the disclosure provides a method for playing back media content with a reduced runtime, the method comprising: parsing the media content; identifying, using one or more processors, one or more removable scenes, the one or more removable scenes comprising scenes that are non-essential to retain a context of the media content; and playing back the media content without playing the removable scenes.

Another aspect of the disclosure provides a system for playing back media content with a reduced runtime, the system comprising: memory; and one or more processors configured to: parse the media content; identify one or more removable scenes, the one or more removable scenes comprising scenes that are non-essential to retain a context of the media content; and playback the media content without playing the removable scenes.

Yet another aspect of the disclosure provides a non-transitory computer-readable medium storing instructions executable by one or more processors for performing a method of playing back media content with a reduced runtime, the method comprising: parsing the media content; identifying one or more removable scenes, the one or more removable scenes comprising scenes that are non-essential to retain a context of the media content; and playing back the media content without playing the removable scenes.

The above and other aspects of the disclosure can include one or more of the following features. In some examples, aspects of the disclosure provide for all of the following features in combination.

In an example, the method further comprises: removing the removable scenes from the media content; and combining remaining portions of the media content after the removable scenes are removed.

In another example, the method further comprises skipping the removable scenes.

In yet another example, the method further comprises dividing the media content into a plurality of segments based on metadata stored with the media content and analyzing each of the plurality of segments to determine removable scenes.

In yet another example, the method further comprises dividing the media content into a plurality of segments based on appearances of important characters identified by image recognition techniques.

In yet another example, the method further comprises dividing the media content into a plurality of segments based on changes in camera angles.

In yet another example, the removable segments include scenes that involve camera angles focused on a character's expression for a prolonged period of time or segments involving a low level of character activities.

In yet another example, the removable scenes include scenes with no dialogue between characters.

In yet another example, the removable scenes include scenes with only background music.

In yet another example, the removable scenes include scenes where only auxiliary characters appear.

In yet another example, the removable scenes are identified using a machine learning model trained to identify duplicate scenes and scenes that are irrelevant to the storyline of the media content.

### BRIEF DESCRIPTION OF THE DRAWINGS

FIG. 1 depicts a block diagram illustrating a media content runtime reduction system according to aspects of the disclosure.

FIG. 2 depicts a block diagram illustrating an example computing system for execution of the media content runtime reduction system according to aspects of the disclosure.

FIG. 3 depicts a block diagram illustrating an example media system according to aspects of the disclosure.

FIG. 4 depicts a flow diagram illustrating an example media content runtime reduction process according to aspects of the disclosure.

### DETAILED DESCRIPTION

The present disclosure provides a system and method for removing or skipping certain segments of media content without affecting the storyline or viewing quality of the media content. The remaining segments may be combined and presented to a viewer as separate media content with a reduced runtime.

Media content may be divided into multiple segments based on changes in themes, camera angles, appearances of main characters, etc. Metadata for the media content may be used in determining how to divide the segments. For example, the metadata may include information such as timestamps corresponding to the changes in camera angles. A machine learning model can alternatively or additionally be used to divide the segments. For example, the machine learning model may be trained to identify changes in scenes, changes in camera angles, etc.

The identified segments can be analyzed to determine whether the segment contains relevant scenes and/or removable scenes. For example, a relevant scene may contain physical actions, such as a handshake, a fight, a car chase, giving a gift, writing a note, or any of a variety of other possible physical actions. In other examples, relevant scenes may include dialogue between characters, particularly the main characters. Removable scenes may include scenes that do not involve actions or dialogue necessary for understanding the story or plot. By way of example, removable scenes can include scenes with extended camera focus on a character for dramatic effect without actions or dialogue, scenes focusing on scenery only, scenes with background music playing, etc. Such scenes may be tagged as removable. The removable scenes can be deleted or skipped during the playback of the media content. The remaining scenes, i.e., the relevant scenes, can be combined and provided for display to the viewer as a shortened version of the media content.

The removable scenes can be any length or duration and can vary in duration from one removable scene to the next. For example, while a first removable scene may be 5 seconds long, another removable scene may be 3 minutes or more. In some examples, the removable scene may have a duration exceeding a threshold. For example, scenes less than a few seconds may be considered too short to make a significant impact on expediting the playback time of the content, and thus while they may be unnecessary, they may be kept to conserve the computing resources that would be required to remove them. In other examples, all removable scenes, regardless of duration, may be skipped or deleted such that playback time is reduced in the aggregate.

According to some examples, the viewer may be provided with an option to select and view the shortened version of the media content before or during streaming the original media content. For example, when selecting a program, movie, or other media content to view, the viewer may be presented with options to watch either the full unabridged version or the expedited shortened version. Accordingly, the viewer may select the desired version. If during viewing of the selected version, the viewer desires to switch to the other version, the viewer may access a menu option allowing the viewer to switch to the other version. In some examples, the viewer may be presented with multiple expedited versions where removable scenes are more or less aggressively identified. For example, the viewer may select a first expedited version where every possible unnecessary scene is removed or a second longer expedited version where removable scenes are less aggressively identified and removed and more of the artistry behind the content is retained.

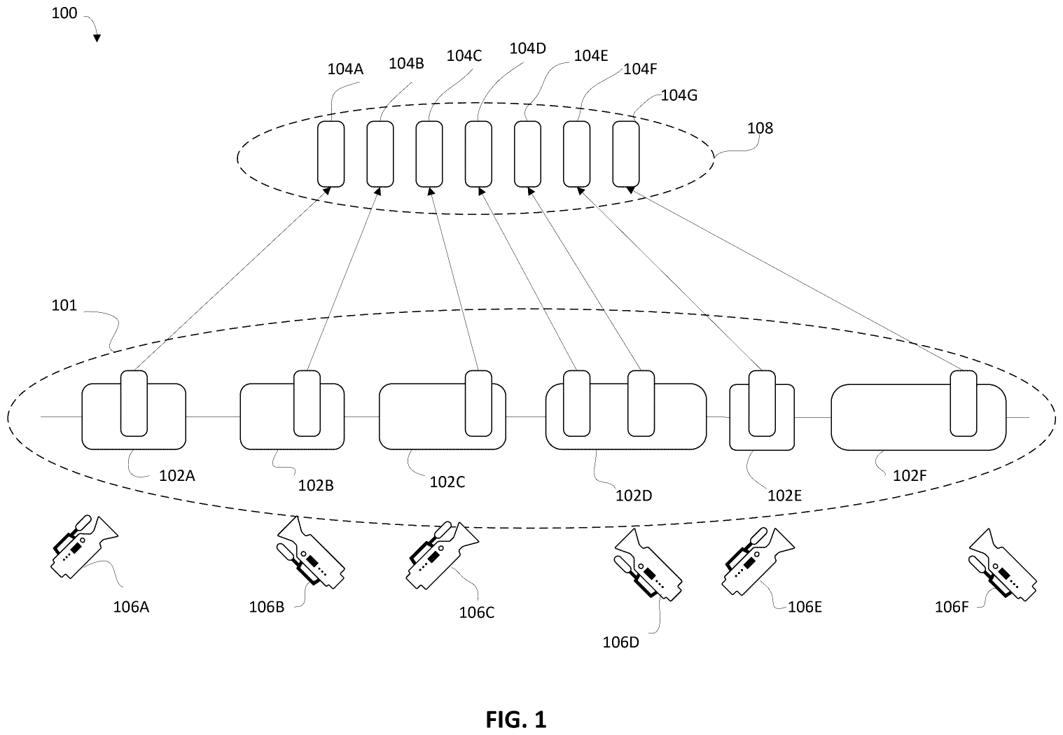

FIG. 1 depicts a block diagram illustrating a media content runtime reduction system. Media content runtime reduction system 100 may receive media content 101 and divide media content 101 into one or more segments such as segments 102A-F. Media content runtime reduction system 100 may analyze each segment, identify main scenes, and remove superfluous scenes from each segment while removal of these scenes would not change the context or viewing quality of media content 101. Main scenes from each segment may be combined as highlight content 108. Highlight content 108 may be provided to a viewer before the viewer starts to play or stream media content 101.

Media content 101 may include any type of sound, images, videos, or similar matter distributed via media platforms such as streaming, social media, websites, mobile applications, television, radio, etc. Media content 101 may include segments 102A-F. Each of segments 102A-F may have a different length and a different number of scenes. Media content 101 may be divided into segments 102A-F based on camera angles 106A-F. For example, each of segments 102A-F may include scenes filmed from the corresponding camera angles 106A-F as shown in FIG. 1. In other examples, segments 102A-F may be identified based on the metadata stored with media content 101. Such metadata may provide information as to when each segment starts and finishes. The metadata may also include the playtime of each segment and the timestamps for characters' entries or exits. Segments 102A-F may also be divided using a machine learning model. The machine learning model may be trained using other media content with similar themes and lengths. The machine learning model can also be trained to identify duplicate segments, segments with no added values, elongated segments from the previous segments, and/or segments irrelevant to the storyline of the media content.

According to some examples, media content runtime reduction system 100 may utilize image recognition techniques to identify and distinguish main characters from auxiliary characters. Media content runtime reduction system 100 may also identify the actions, monologues, or dialogues of the main characters and divide media content 101 into segments 102A-F based on actions made or lines spoken by the main characters.

Media content runtime reduction system 100 may analyze each of segments 102A-F to identify the main scenes. The main scenes may be identified based on physical actions performed by the main characters or dialogs between the main characters. Irrelevant scenes may also be identified. Irrelevant scenes may include scenes with only background music with no major physical actions or scenes where a camera focus on a character remains for a prolonged time. Irrelevant scenes may also include scenes with no background setting changes with only one angle or scene where no main characters are present. Media content runtime reduction system 100 may identify main scenes 104A-G from segments 102A-F, respectively.

Media content runtime reduction system 100 may tag the remaining portions of each of segments 102A-F besides main scenes 104A-G as “removable”. The tagged portions of each segment may be removed from each segment or skipped during playback. If the tagged portions are removed from each segment, the unremoved portions (i.e., main scenes 104A-G) may be stitched together to create a piece of separate media content, highlight content 108. If the tagged portions are skipped, highlight content 108 may still contain the entire portion of media content 101 but the flagged removal scenes may be automatically fast-forwarded until reaching one of the main scenes 104A-G during the playback.

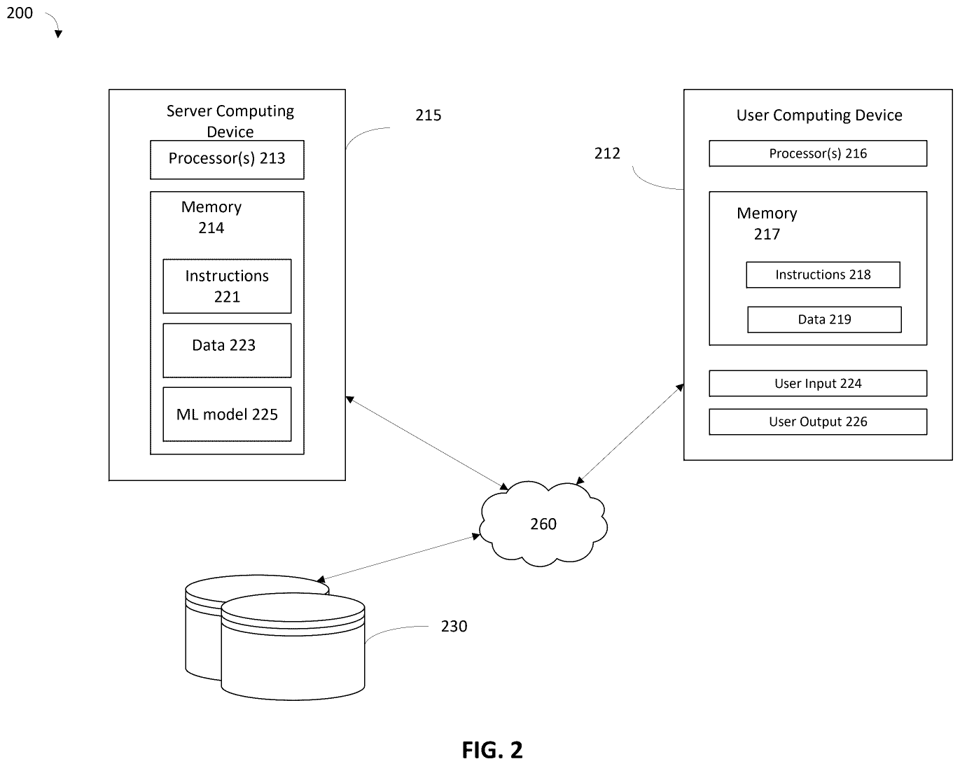

FIG. 2 depicts a block diagram illustrating example components of a media content runtime reduction system User computing device 212 may include a television, mobile computing device, or other user device with a display that can be adapted to display media content. Server computing device 215 may be a component of media content runtime reduction system 100 illustrated in FIG. 1. Server computing device 215 may provide the media content to the user computing device 212 for display. Server computing device 215 may further provide metadata related to the media content. For example, the metadata includes information as to how the media content can be divided into one or more segments. User computing device 212 may transmit a request from a viewer to server computing device 215 to view a shortened version of the media content such as highlight content 108 as illustrated in FIG. 1. Storage devices 230 may store the highlight content. In response to receiving the request, server computing device 215 may retrieve the highlighted content from storage device 230. The retrieved highlight content may be displayed on a display of user computing device 212.

User computing device 212 and the server computing device 215 can be communicatively coupled to one or more storage devices 230 over a network 260. The storage device(s) 230 can be a combination of volatile and non-volatile memory and can be at the same or different physical locations than the computing devices 212, 215. For example, the storage device(s) 230 can include any type of non-transitory computer-readable medium capable of storing information, such as a hard-drive, solid state drive, tape drive, optical storage, memory card, ROM, RAM, DVD, CD-ROM, write-capable, and read-only memories.

The server computing device 215 can include one or more processors 213 and memory 214. Memory 214 can store information accessible by the processor(s) 213, including instructions 221 that can be executed by the processor(s) 213. Memory 214 can also include data 223 that can be retrieved, manipulated, or stored by the processor(s) 213. Memory 214 can further include machine learning model 225. Machine learning model 225 may be trained to identify duplicate segments, elongated segments from the previous segments, or irrelevant segments from the original media content and divide the media content into one or more segments based on the identified duplicate, elongated, or irrelevant segments.

Memory 214 can be a type of non-transitory computer-readable medium capable of storing information accessible by the processor(s) 213, such as volatile and non-volatile memory. The processor(s) 213 can include one or more central processing units (CPUs), graphic processing units (GPUs), field-programmable gate arrays (FPGAs), and/or application-specific integrated circuits (ASICs), such as tensor processing units (TPUs).

Instructions 221 can include one or more instructions that when executed by the processor(s) 213, cause the one or more processors to perform actions defined by the instructions. Instructions 221 can be stored in object code format for direct processing by the processor(s) 213, or in other formats including interpretable scripts or collections of independent source code modules that are interpreted on demand or compiled in advance. Instructions 221 can include instructions for implementing processes consistent with aspects of this disclosure. Such processes can be executed using the processor(s) 213, and/or using other processors remotely located from the server computing device 215.

The data 223 can be retrieved, stored, or modified by the processor(s) 213 in accordance with instructions 221. Data 223 can be stored in computer registers, in a relational or non-relational database as a table having a plurality of different fields and records, or as JSON, YAML, proto, or XML documents. Data 223 can also be formatted in a computer-readable format such as, but not limited to, binary values, ASCII, or Unicode. Moreover, data 223 can include information sufficient to identify relevant information, such as numbers, descriptive text, proprietary codes, pointers, references to data stored in other memories, including other network locations, or information that is used by a function to calculate relevant data.

User computing device 212 can also be configured similar to the server computing device 215, with one or more processors 216, memory 217, instructions 218, and data 219. The user computing device 212 can also include a user output 226, and a user input 224. The user input 224 can include any appropriate mechanism or technique for receiving input from a user, such as a keyboard, mouse, mechanical actuators, soft actuators, touchscreens, microphones, and sensors.

Server computing device 215 can be configured to transmit data to the user computing device 212, and the user computing device 212 can be configured to display at least a portion of the received data on a display implemented as part of the user output 226. The user output 226 can also be used for displaying an interface between the user computing device 212 and the server computing device 215. The user output 226 can alternatively or additionally include one or more speakers, transducers, or other audio outputs, a haptic interface or other tactile feedback that provides non-visual and non-audible information to the platform user of the user computing device 212.

Although FIG. 2 illustrates the processors 213, 216 and the memories 214, 217 as being within the computing devices 215, 212, components described in this specification, including the processors 213, 216 and the memories 214, 217 can include multiple processors and memories that can operate in different physical locations and not within the same computing device. For example, some of the instructions 221, 218 and the data 223, 219 can be stored on a removable SD card and others within a read-only computer chip. Some or all of the instructions and data can be stored in a location physically remote from, yet still accessible by, the processors 213, 216. Similarly, processors 213, 216 can include a collection of processors that can perform concurrent and/or sequential operations. Computing devices 215, 212 can each include one or more internal clocks providing timing information, which can be used for time measurement for operations and programs run by computing devices 215, 212.

The server computing device 215 can be configured to receive requests to process data from the user computing device 212. For example, environment 200 can be part of a computing platform configured to provide a variety of services to users, through various user interfaces and/or APIs exposing the platform services. One or more services may include automatically creating a new version of the media content by reducing the runtime without affecting quality or changing the context of the storyline of the media content.

Devices 212, 215 can be capable of direct and indirect communication over network 260. Devices 212, 215 can set up listening sockets that may accept an initiating connection for sending and receiving information. The network 260 itself can include various configurations and protocols including the Internet, World Wide Web, intranets, virtual private networks, wide area networks, local networks, and private networks using communication protocols proprietary to one or more companies. Network 260 can support a variety of short- and long-range connections. The network 260, in addition, or alternatively, can also support wired connections between devices 212, 215, including over various types of Ethernet connection.

Although a single server computing device 215 and user computing device 212 are shown in FIG. 2, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

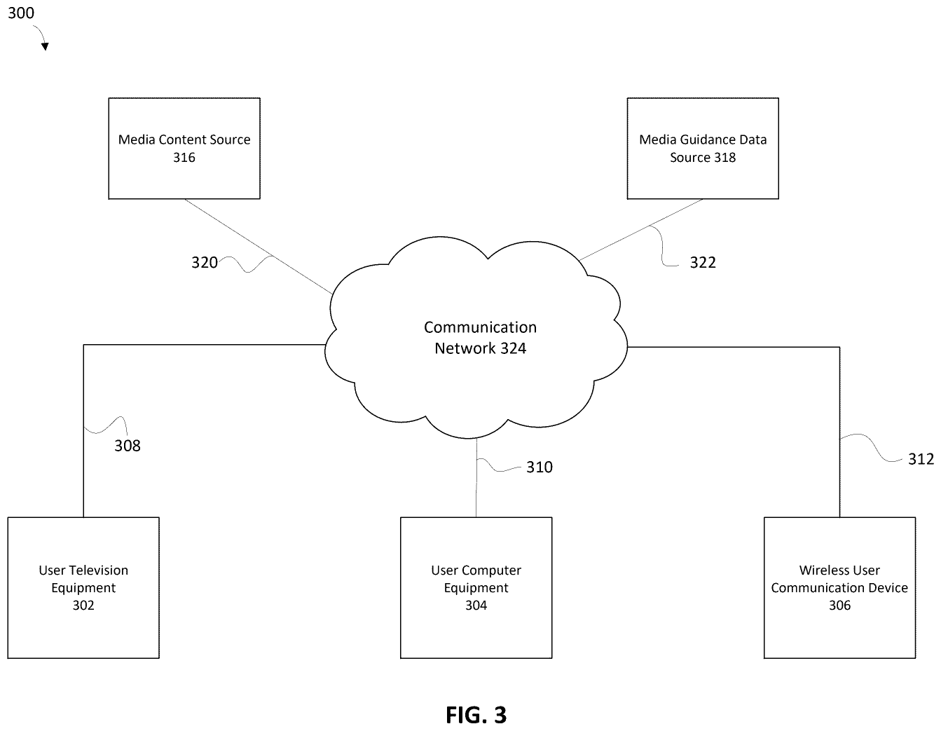

FIG. 3 depicts a block diagram illustrating an example media system 300. Media system 300 may include user television equipment 302, user computer equipment 304, wireless user communication device 306, media content source 316, and media guidance data source 318 are coupled to communication network 324 via paths 308, 310, 312, 320, and 322. User television equipment 302, user computer equipment 304, and wireless user communication device 306 may comprise one or more user computing devices 212 as illustrated in FIG. 2. Media content source 316 and media guidance data 318 may comprise one or more server computing devices 215 as illustrated in FIG. 2. User computer equipment 304 and user television equipment 302 may be Internet-enabled and allow for access to Internet content. User computer equipment 304 may include a tuner allowing for access to television programming. A media guidance application may be tailored to the display capabilities of both user computer equipment 304 and user television equipment 302. For example, on user computer equipment 304, the guidance application may be provided as a website accessed by a web browser. Paths 308, 310, 312, 320, and 322 may include one or more communication paths, such as a satellite path, a fiber-optic path, a cable path, a path that supports internet communication, or any other suitable wired or wireless communication path, or a combination of such paths.

Media content source 316 may include one or more types of content distribution equipment including a television distribution facility, cable system headend, satellite distribution facility, programming source, intermediate distribution facilities and/or server, internet providers, on-demand media server, and other content providers. Media content source 316 may also include cable sources, satellite providers, on-demand providers, Internet providers, over-the-top content providers, or other providers of content. Media guidance data source 318 may provide media guidance data. Media guidance data may include an interactive television program guide that receives program guide data via a data feed. The media guidance data may also include metadata related to dividing the media content into one or more segments. Such metadata includes, for example, whether the camera angle changes at a specific point of the media content, whether main characters perform actions, or whether each segment has irrelevant scenes such as scenes where only background music with a prolonged focus on a character's face.

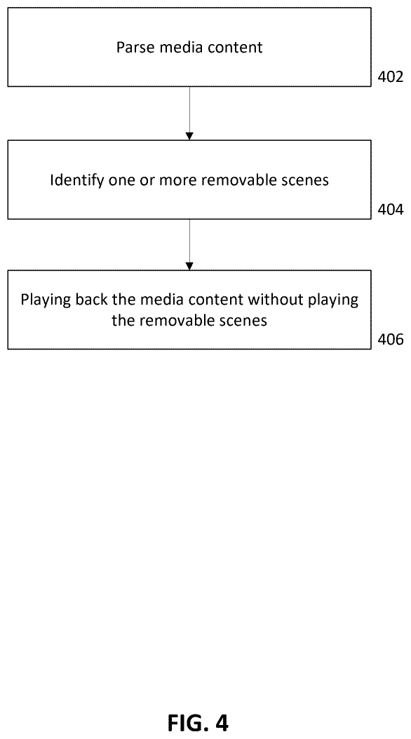

FIG. 4 depicts a flow diagram illustrating an example media content runtime reduction process. According to block 402, the media content runtime reduction system may parse media content. The media content runtime reduction system may analyze the entire length of the media content and identify a plurality of segments based on the metadata stored with the media content. The media content runtime reduction system may also utilize a machine learning model trained to divide the media content into a plurality of segments based on identified changes in scenes, changes in camera angles, etc.

According to block 404, the media content runtime reduction system may identify one or more removable scenes within the plurality of segments. The removable scenes may be determined based on the importance of the scenes within the plurality of segments relative to the story or plot of the media content. For example, the media content runtime reduction system may identify scenes that involve major physical actions. Alternatively, or additionally, the media content runtime reduction system may identify other scenes that do not involve any major action or plot development or scenes that are irrelevant to the context of the storyline. The identified scenes may be tagged. For example, major or important scenes may be tagged as such, and/or irrelevant or unnecessary scenes may be tagged as removable scenes. Such tagging may include, for example, marking the beginning and ending segments of such scenes in metadata and assigning a label indicating how the scene was assessed.

According to block 406, the media content runtime reduction system may play back the media content without playing the removable scenes. The media content runtime reduction system may remove or skip the removable scenes. The remaining scenes may be stitched together to generate a shortened version of the media content. If the removable scenes are only skipped, the viewer may be provided with the full length of the media content, but the removable scenes may be automatically fast-forwarded until reaching the next scene that is not flagged as removable.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

Although the technology herein has been described with reference to particular examples, it is to be understood that these examples are merely illustrative of the principles and applications of the present technology. It is therefore to be understood that numerous modifications may be made and that other arrangements may be devised without departing from the spirit and scope of the present technology as defined by the appended claims.

Unless otherwise stated, the foregoing alternative examples are not mutually exclusive but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method for playing back media content with a reduced runtime, the method comprising:
parsing the media content;
identifying, using one or more processors, one or more removable scenes, the one or more removable scenes comprising scenes that are non-essential to retain a context of the media content; and
playing back the media content without playing the removable scenes.

2. The method of claim 1, further comprising:
removing the removable scenes from the media content; and
combining remaining portions of the media content after the removable scenes are removed.

3. The method of claim 1, further comprising skipping the removable scenes.

4. The method of claim 1, further comprising dividing the media content into a plurality of segments based on metadata stored with the media content and analyzing each of the plurality of segments to determine removable scenes.

5. The method of claim 1, further comprising dividing the media content into a plurality of segments based on appearances of important characters identified by image recognition techniques.

6. The method of claim 4, further comprising dividing the media content into a plurality of segments based on changes in camera angles.

7. The method of claim 1, wherein the removable segments include scenes that involve camera angles focused on a character's expression for a prolonged period of time or segments involving a low level of character activities.

8. The method of claim 1, wherein the removable scenes include scenes with no dialogue between characters.

9. The method of claim 1, wherein the removable scenes include scenes with only background music.

10. The method of claim 1, wherein the removable scenes include scenes where only auxiliary characters appear.

11. The method of claim 1, wherein the removable scenes are identified using a machine learning model trained to identify duplicate scenes and scenes that are irrelevant to the storyline of the media content.

12. A system for playing back media content with a reduced runtime, the system comprising:
memory; and
one or more processors configured to:
parse the media content;
identify one or more removable scenes, the one or more removable scenes comprising scenes that are non-essential to retain a context of the media content; and
playback the media content without playing the removable scenes.

13. The system of claim 12, wherein the one or more processors are further configured to:
remove the removable scenes from the media content; and
combine remaining portions of the media content after the removable scenes are removed.

14. The system of claim 12, wherein the one or more processors are further configured to skip the removable scenes.

15. The system of claim 12, wherein the one or more processors are further configured to divide the media content into a plurality of segments based on metadata stored with the media content and analyze each of the plurality of segments to determine removable scenes.

16. The system of claim 12, wherein the one or more processors are further configured to divide the media content into a plurality of segments based on appearances of important characters identified by image recognition techniques.

17. The system of claim 16, wherein the one or more processors are further configured to divide the media content into a plurality of segments based on changes in camera angles.

18. The system of claim 12, wherein the removable scenes include scenes that involve camera angles focused on a character's expression for a prolonged period of time or scenes involving a low level of character activities.

19. The system of claim 12, wherein the removable segments include scenes with no dialogue between characters.

20. A non-transitory computer-readable medium storing instructions executable by one or more processors for performing a method of playing back media content with a reduced runtime, the method comprising:
parsing the media content;
identifying one or more removable scenes, the one or more removable scenes comprising scenes that are non-essential to retain a context of the media content; and
playing back the media content without playing the removable scenes.
